(19) United States
(12) Patent Application Publication
(10) Pub. No.: US 2004/0051393 A1
(43) Pub. Date: Mar. 18, 2004

(54) Electrical power control system

(76) Inventor: Anthony Brotherton Ratcliffe, Lewes (GB)

Correspondence Address: LARSON & TAYLOR, PLC, 1199 NORTH FAIRFAX STREET, SUITE 900, ALEXANDRIA, VA, 22314, US

(21) Appl. No.: 10/416,922

(22) PCT Filed: Nov. 19, 2001
(86) PCT No.: PCT/GB01/05086

(30) Foreign Application Priority Data
Nov. 17, 2000 (GB) 0028093.3

(51) Int. Cl. H01H 1/00

(52) U.S. Cl. 307/112

(57) ABSTRACT

Apparatus is disclosed for controlling the supply of electrical power to an appliance such as a television, amongst many others. The apparatus comprises a controller that is operative to complete or to disconnect a supply of electricity to electrical apparatus in accordance with a programmed time schedule. The system further comprises one or more programming objects, such as RFID cards, by means of which a time schedule can be programmed in the controller, the programming object being removable from the controller during its normal operation.

The present invention relates to electrical power control systems. More particularly, the invention relates to a system whereby the supply of electrical power to an appliance can be controlled and/or monitored.

Situations arise in which it is desirable to give an authorised person control over the extent to which electrically powered apparatus is used. For example, a parent may wish to exercise control over the amount of time that a child spends watching television or using a computer. In such applications, it is most important that the system used to apply such controls is highly resistant to the frequent and often ingenious attempts that a child might make to overcome its control without being detected by the parents. In another example, a business may wish to restrict use of its equipment, such as a computer or a photocopier, to a period within normal working hours or ensure that the daily use of a piece of equipment does not exceed a recommended duty cycle. Use of certain, for example, hazardous or medical equipment may be restricted to qualified personnel.

Various systems have been proposed to limit the total time that an appliance can be used. Simple known systems have little or no ability to change the programme of time within which the appliance can be used, which may be too inflexible in many applications. It is also known to provide a fully programmable controller that can be controlled by means of a keypad. This type of system is generally difficult to re-program quickly, and may require a user to memorise an identification number to gain access to the system. This can be inconvenient where a large number of such systems are to be maintained by a user: they may all have the same identification number, in which case, all their security is compromised if the number is divulged, or that all may have a different number, which can present a considerable challenge to the user's memory.

An aim of this invention is to attempt to overcome or at least mitigate the disadvantages of these known systems.

In a first aspect, the invention provides a controller for controlling the supply of electrical power to an appliance, the controller being operative to complete or to disconnect a supply of electricity to electrical apparatus in accordance with a programmed time schedule, the time schedule of the controller being programmable by means of a programming object that is removable from the controller during its normal operation.

Thus, removing the programming object from the controller removes the ability to reprogram the controller. Provided that the programming object is maintained securely, the user of the apparatus cannot override the programme set by the authorised person.

In typical embodiments of the invention the schedule defines a maximum period of operation of the appliance within a time interval. Most typically, the time interval is a day. This allows an authorised person to limit the amount of time that an appliance can be used in a day. Thus, in a typical embodiment, the programmed time schedule permits the appliance to be operated for a predetermined duration in each period of 24 hours. In such embodiments, the schedule may be varied in dependence upon the day of the week. For example, a first schedule can be specified for week days and an alternative period is specified for weekend days. This may be especially useful where the controller is applied to apparatus the use of which is connected with, or can interfere with, normal activities during a working week.

A controller embodying the invention may be operative to interact with the programming object without making an electrical connection with it. This greatly facilitates use of the controller, and avoids the need for a user to position the programming object accurately for use. For example, the programming object may be operative to interact with the controller by exchange of electromagnetic signals, and in particular RF signals. In such embodiments, the controller may be operative to interact with an RFID card. In particular, such cards may be arranged to interact with the controller when the card is brought into close proximity with the controller.

In order to enhance the security of the apparatus, a controller embodying the invention may be configured not to respond to a programming object until that object (or class of objects) has been enrolled for use with the controller. This reduces the risk that a programming object from one installation of apparatus embodying the invention can be used, without authorisation, to re-program another installation of the invention.

In a preferred embodiment, each programming object can be enrolled for use in a controller by first introducing an enrolment programming object to the controller and then introducing a further programming object that is to be enrolled or by introducing an enrolment card having a code such as a site code which is common to a set of programming cards to be enrolled.

A controller embodying the invention may be configured to receive and secure a power supply cord for the appliance. Alternatively, the controller may be configured to permit the supply cord to be directly wired into the controller. The supply cord will normally be hard-wired to the appliance. However, in the case of an appliance with a removable “kettle plug” IEC connector, preferably, a locking connector is provided. This may lock the socket to the appliance, for example by retaining the pins on the power supply plug of the appliance.

Alternatively, the controller may be configured to receive and secure a mains supply plug to which the supply cord is connected. For example, the plug may be secured beneath a locking lid that can be opened by an authorised person. In such embodiments, an appliance can be connected to a controller embodying the invention without requiring a user to have electrical wiring skills. Advantageously, the lid can be opened under the control of a programming object. This removes the need for an external lock (and an appropriate key) and is therefore very convenient for a user.

Alternatively, the lid can be opened by release of a physical lock, such as a key operated lock. Having a physical lock to secure the plug may facilitate operation without power and may increase security.

Preferably, the controller further comprises means for detecting when the lid is open. This information may be stored and interrogated by an authorised user, either directly or over a network.

A further preferable feature is that opening of the lid causes the controller to enter a mode in which additional programming of the controller is enabled. More preferably, the mode allows programming objects to be enrolled for use with the controller. This may increase the speed with which cards may be enrolled for use by an authorised user. It may also remove the need for an enrolment card programming object to be presented to the controller each time a new card is enrolled.

Another preferable feature is that at least one of the fixing means used to secure the casing of the controller is obscured when the lid is closed. More preferably, all of the fixing means are obscured when the lid is closed. The casing of the controller may be manufactured in two parts, which may then be screwed or otherwise fixed together to form a complete casing for the controller mechanism. Obscuring at least one of the fixings under the locking lid may prevent disassembly of the controller whilst it is attached to an appliance.

Optionally, the power supply cord may be connected to the appliance via a plug or socket. In this embodiment, the supply cord may be provided with a locking plug or socket to secure the supply cord to the appliance. The plug may further be secured within a socket which allows insertion of the pins of the plug into the socket, but which inhibits removal, for example by seizing at least one of the pins of the plug to prevent removal of the plug from the socket. This may be a further security feature, in addition to the locking lid, or may be provided as an alternative to the locking lid.

Preferably, the socket further comprises a release mechanism which may incorporate one or more of the preferable features of the release mechanism of the locking lid, described above.

From a second aspect, the invention provides apparatus for controlling the supply of electrical power to an appliance comprising a controller according to the first aspect of the invention and one or more programming objects

Typically, such apparatus includes a plurality of programming objects, each of which performs a predetermined programming function. For example, the apparatus may include one or more of the following: a programming object that sets a predetermined time schedule, a programming object that effects an incremental change to a time schedule (for example, by adding or removing an hour), a programming object that resets the apparatus to a default condition, a programming object that permits unlimited use of the appliance and a programming object that prohibits all use of the appliance. Within an organisation, this can, for instance, allow a supervisor to restrict distribution of certain programming objects to other members of staff and thereby exercise a global control over the extent to which apparatus throughout the organisation can be re-programmed.

Apparatus according to the last-preceding paragraph may include programming objects which perform administrative tasks such as setting a clock or releasing a power connector from the controller. This can allow the apparatus to be programmed and controlled entirely by means of programming objects, and without the need to use a keypad or other input devices. Each programming object is preferably labelled to indicate the programming function that it will perform. More preferably, at least two of the programming objects, each having a defined function, are readily mutually visibly distinct (e.g. distinguishable from a distance, e.g. of at least 2 m). Preferably, each of the mutually visibly distinct programming objects has a unique colour. If the programming objects are easily identifiable, this may increase the speed with which the controller may be programmed.

It is particularly preferred to provide a set contaning at least three programming objects, one of which adds a predetermined increment of time, one of which removes a predetermined increment of tune and one of which performs at least one of the following functions: cancelling all allowance of time for a predetermined period (e.g. a day), allowing uninterrupted use of the appliance for a predetermined period (e.g. a day).

In typical embodiments, in apparatus embodying this aspect of the invention the or each programming object includes an electronic token.

Preferably, a controller in apparatus embodying the invention will act upon programming object only if that object has been previously enrolled for use with the controller. This prevents unauthorised re-programming of the controller of one installation of the apparatus with programming objects obtained from another installation of the apparatus.

In one embodiment, each programming object can be enrolled for use in a controller by first introducing an enrolment programming object to the controller and then introducing a further programming object that is to be enrolled. Alternatively, programming objects may be enrolled by placing the controller in a programming mode, for example by operating a key switch which optionally also opens the locking lid.

In many cases, multiple apparatus embodying the invention will be installed by an organisation to control many electrical appliances. In such cases, one programming object (or set of programming objects) may be provided to control a plurality of controllers. With this in mind, a system embodying the invention may permit each programming object and each controller can be programmed with an authorisation code, each controller responding only to those programming objects that have an appropriate authorisation code. For example, the authorisation code corresponds to a geographical limitation, a department within the organisation, or a type or class of appliance.

From a third aspect, the invention provides a system for controlling the time of operation of an electrical appliance comprising a controller and a set of objects for programming the controller, in which the controller is operative to complete or interrupt a power supply circuit to an appliance in accordance with a timing programme, the timing programme being configurable by a user by means of the programming objects.

It may be that one person will be responsible for many appliances controlled by a system embodying the invention. Therefore, a system embodying this aspect of the invention may comprise a plurality of controllers that can be programmed by one set of programming objects.

In a system embodying the invention, each programming object is preferably labelled to indicate the programming function that it will perform (the objects may otherwise appear substantially identical).

Each programming object may advantageously be used to perform its function by bringing it into proximity with the controller. For example, each programming object may be or may include an RFID card.

In a system embodying the invention, each controller can be connected to a mains supply and has a mains outlet socket into which a mains plug of an appliance can be inserted and secured to resist unauthorised removal. Most advantageously, removal of the plug can be accomplished by introducing a suitable programming object to the controller, thereby removing the need for a user to use keys or other tools.

From a fourth aspect, the invention provides a programming object for controlling the function or for programming a controller for controlling the supply of electrical power to an appliance. Such a programming object will typically be used in or in conjunction with embodiments of preceding aspects of the invention.

Such a programming object may comprise an electronic token, which may comprise an RFID card.

The programming object will typically comprise a token encoded with an identification code or instructions that serve (1) to identify the token as a programming object for a power controller (2) to identify the token as having a particular site or authorisation code and (3) to instruct the controller to perform a specified action, for example one of the following actions:—to release a plug, to enrol a card, to set the time, to set a schedule, to add time to an existing schedule.

Moreover, the invention may provide a set of programming objects each embodying the fourth aspect of the invention, each of which is configured to perform a specific programming or control function. Such a set of programming objects can be used by a user to perform a desired range of programming and other functions on a controller. In such a set, each object preferably bears an indication of the function that it is configured to perform. Preferably, at least two of the programming objects are mutually visibly distinct objects, each having defined functions. More preferably, each of the visibly distinguishable programming objects has a unique colour. Most preferably, the invention provides a set of at least three programming objects having defined functions, the objects each having a different colour.

From a fifth aspect, the invention provides a method of programming a controller for controlling an electrical appliance in which one or more programming objects is presented to the controller, each programming object causing the controller to perform a specified programming function.

To provide a degree of security against unauthorised reprogramming, the method typically includes a further step in which the programming objects are removed from the vicinity of the controller following programming of the controller.

An embodiment of the invention will now be described in detail, by way of example and with reference to the accompanying drawings, in which:

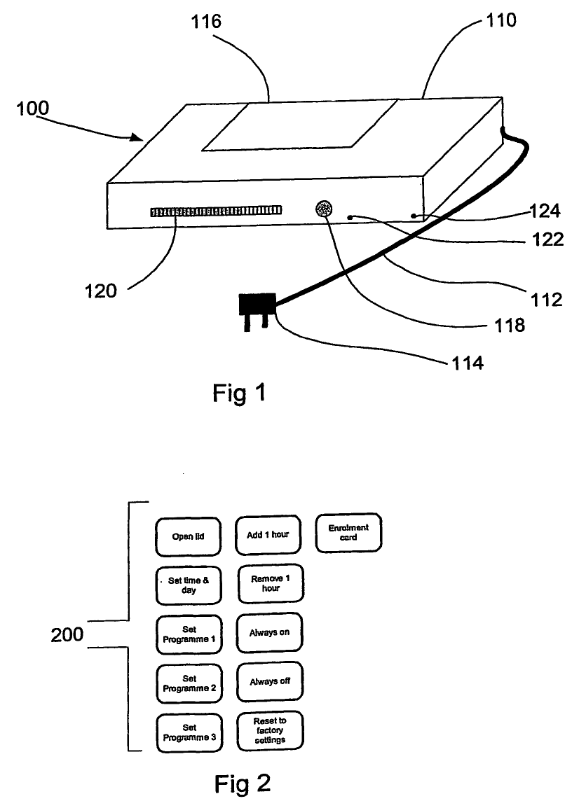

FIG. 1 is a diagrammatical illustration of a controller being a component of an embodiment of the invention;

FIG. 2 is a diagrammatical illustration of controlling objects being components of the embodiment of FIG. 1;

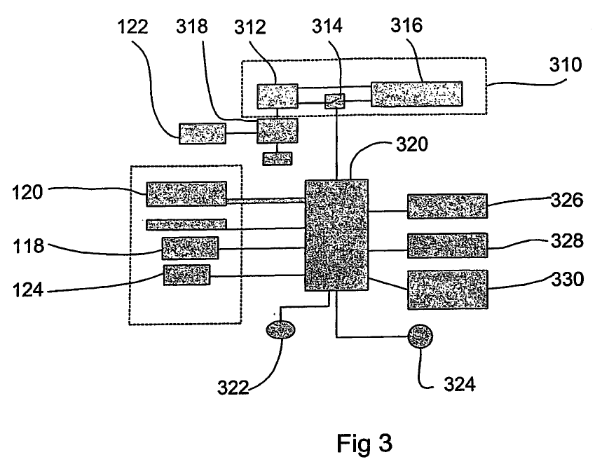

FIG. 3 is a block diagram of functional components of the controller of FIG. 1.

With reference to FIGS. 1 and 2, a system embodying the invention consists of the following main components: a controller 100 and a set of programming objects 200.

The controller includes an equipment case 110 that encloses the operative components of the controller 100. A power supply lead 112 extends from the case 110 and terminates in a mains electrical plug 114 of a configuration that is suitable for connecting with a mains electrical supply. A lid 116 covers a recess in an outer wall of the case 110. Within the recess there is an electrical socket outlet (316 in FIG. 3) that can receive a mains electrical plug of an appliance. Access to the socket outlet can be gained only when the lid 116 is in an open condition, as will be described in more detail below. The case 110 also carries a power switch 118, a display 120, a mains-on indicator 122, and a power-on indicator 124 which will also be described below.

The set of programming objects 200 includes a plurality of RFID cards. Externally, the cards are generally similar, but each bears a label to indicate its function. Internally, each of the cards is provided with suitable circuitry to interact with the components within the controller 100, each card being programmed to transmit to the controller a predetermined identification signal.

In this embodiment, the cards are labelled as follows: “Open lid”, “Set time & day”, “Set Programme 1”, “Set Programme 2”, “Set Programme 3”, “Add 1 hour”, “Remove 1 hour”, “Always on”, “Always off”, “Reset to factory settings”, and “Enrolment card”.

As an alternative to the card labels, or as an additional feature, at least some cards may be coloured to indicate their functions. In one embodiment, the “Add 1 hour” card may be coloured green, the “Remove 1 hour” card may be yellow, and the “Always off” card may be red. This may allow the cards to be more easily identified by the user, particularly at a distance.

With reference to FIG. 3, the controller 100 includes a power control stage 310. The control stage includes a mains input 312 which receives a supply of mains power from the power supply lead 112. When the controller is switched on, the mains input 312 supplies mains power to the socket outlet 316 through a relay 314. The relay has switch contacts that can selectively electrically connect or isolate the power supply 312 and the socket outlet 316.

The mains input 312 also supplies mains power to a power supply unit 318 that provides a low voltage (in this case 12V) output for electronic components of the controller 100. It also supplies power to the mains-on indicator 122.

The controller 100 is controlled by a programmable microcontroller 320, which includes a processor, memory, and a real-time clock. A backup battery 322 is provided to maintain the content of the memory of the microcontroller 320. The unit may include a receiver for receiving a time clock signal, for example a GPS receiver for receiving GPS time or a radio receiver for receiving a radio signal containing a time signal such as the low frequency signal broadcast in the United Kingdom from Rugby; circuit modules for receiving such time signals are commercially available and will not be described in detail.

The microcontroller 320 has outputs that are connected to the display 120 and the power-on indicator 124 and has an input that is connected to the power switch 118. In addition, the microcontroller 320 has an output that can drive a sounder 324, and optionally, inputs from a network connection 326 and a serial port. Finally, the microcontroller 320 has an input from a RFID card reader 330. An output of the microcontroller 320 is connected to the relay 314 such that the relay contacts can be opened and closed under control of the microcontroller 320.

To commission the system, the following procedure is followed:

The electrical plug 114 of the controller 100 is plugged into a mains socket, and the controller switched on by means of the power switch 118.

The card labelled ‘Open lid’ is presented to the case 110 to be detected by the RFID card reader 330. This is detected by internal components of the controller, which cause the lid 116 to be unlocked. The lid 116 can then be opened by an operator. Once the lid 116 is opened, the mains plug that supplies power to an appliance is inserted into the socket outlet within the recess. The lid 116 is then closed by the user; it is locked automatically. The controller may further detect when the lid 116 is open. This information may be made available to the operator of the controller by enquiry or, in certain applications, over a network or through allowing access to a log file stored in the memory of the controller.

With the lid 116 closed, at least some of the screws or fixings that would allow disassembly of the controller are obscured or inaccessible. Hence it is not possible to remove the controller from the appliance without first opening the lid 116.

In the embodiment of FIG. 1, the lid 116 may be locked electronically requiring a card to open it. In another embodiment, the opening mechanism of the lid 116 may comprise a key, wherein the key may be used both to open the lock on the lid 116 of the case 110 and to enable programming of the controller, as described in more detail below.

In a further alternative embodiment, the lid 116 is replaced by a locking connector. The locking connector is a socket which allows easy insertion of the mains plug of the appliance into the controller, but retains the plug in the socket by seizing at least one of the pins of the plug. The locking connector may further be provided with a release mechanism to allow release of the plug from the controller by an authorised operator. The release mechanism may comprise a key lock or an electronic lock, which may be operated by a card such as those described above.

In another embodiment, the controller may incorporate a supply cord which provides an electrical connection between the controller and the appliance. At one end, the supply cord is wired into the controller. At the other end of the supply cord is a connector, such as a IEC (“kettle plug”) socket, for connection to the appliance. The socket may comprise a locking connector socket, as described above, which allows insertion of the plug into the socket, but prevents removal of that plug except by authorised users who may operate the release mechanism

Once the controller 100 is switched on, it will operate in accordance with a predetermined programme that has been set during manufacture of the controller. The battery 322 may have retained the correct time in the real-time clock of the microcontroller 320; otherwise, the real-time clock must be re-set.

In this embodiment, the time is set as follows: at 9.00am the user presents the card labelled “Set time & day” to the card reader 330. The microcontroller causes the display 120 to show ‘Mon, 9.00am’ and sets the real-time clock appropriately. The user can then present the card again, and the microcontroller 320 will cause the front display to register ‘Tues, 9.00am’ and update the real-time clock. This can be repeated until the correct date and time is shown. If the unit does not include a time signal receiver, the user may set the time.

The user can then set the programme to limit the extent to which the appliance can be used. This can be achieved by presenting a card containing an appropriate preset programme to the card reader 330. In this embodiment, the programmes are as follows:

| Card Label | Weekdays | Weekend |
|---|---|---|
| Set programme 1 | 2 hours | 4 hours |
| Set programme 2 | 3 hours | 5 hours |
| Set programme 3 | 4 hours | 6 hours |

In one embodiment, programming may be implemented through a combination of the key being inserted into the controller and a programming object 200 being presented to the controller. This may increase the security of the programming mechanism. Alternatively, or in addition to using cards to programme the appliance, the turning of the key in the controller may itself be used to select from a number of preset programmes.

The display 120 is driven by the microcontroller 320 to give a visual indication of above how many minutes of power is currently available.

The power-on indicator 124 is lit by the microcontroller 320 to indicate that the relay is closed and power is flowing through the device to the appliance. The mains-on indicator 122 is lit to indicate the presence of a mains supply to the controller 100.

In an application such as restricting viewing time of a television, the following might typically happen. Each day, at 2.00am, the microcontroller will be refreshed with that day's allocation of time and update the display 120 accordingly. When the microcontroller is refreshed, the relay contacts do not automatically close, since this would supply power to the television. This supply of power may cause some televisions (or other appliances) to switch to standby mode, but may cause other televisions to switch on directly. In order to avoid. the appliance switching on unattended whenever the microcontroller is refreshed, the user must press the ‘Power On’ button 118 to activate the power supply. The microcontroller 320 then causes the relay contacts to close so that power can flow to the television set, and continuously decreases the amount of time left in the time allocation. The television can be watched from this moment on until the time allocation expires. The controller will sense when the television is on, by monitoring the current flow through the cable to the television set. When the viewing allocation is over, or the viewing period ends, the microcontroller 320 causes the relay 314 to open its contacts, thereby disconnecting power from the television set. As mentioned above, a current sensor in the controller monitors the supply of power to the appliance. The current sensor is preferably able to determine whether the appliance is on (high current), off, or in standby mode (low current).

In one embodiment, operation of the appliance may be restricted to certain periods of the day. The current sensor within the controller can determine the status of the appliance when the time period during which the appliance may be used comes to an end. If the appliance is switched on at this time, the controller opens the relay contacts to cut power to the appliance and switch it off. If the appliance is switched off, or in is in standby mode at the end of the allowable time period, then the apparatus may be configured so that the relay contacts are not opened and the appliance can remains in its “off” or “standby” mode. However, if the appliance is switched on before the start of the next time period in which the appliance may be used, then the controller opens the relay contacts to cut power to the appliance and prevent its use. As discussed above, the relay contacts are not automatically closed again at the start of the next allowable time period in order to avoid the appliance switching on unattended.

At any time during the day, the following functions can be carried out by presenting the appropriate card.

Add or remove 1 hour from the time allocation (this can be repeated)

Remove 1 hour

Always on

Always off

Other RFID access cards may be enrolled by the means of the enrolment card. To allow access to the appliance for an hour per 24 hour period, the following RFID cards are presented: Enrolment card, Access card, Add 1 hour card. To allow full access to the appliance for a 24 hour period, the following RFID cards are presented: Enrolment card, Access card, Always on card.

Reference is made above to an “Access” card. The unit may be integrated or compatible with electronic access systems and a card used to afford access to a building may also be enrolled with the controller and programmed to afford access to power for a pre-determined time. For example, in an office, an entry card may be programmed to allow 15 minutes access for example in a controller connected to a photocopier.

In an alternative embodiment, opening of the lid 116 of the controller may automatically cause the controller to enter a mode in which new cards may be enrolled into the system. This may remove the need for an Enrolment card to be presented to the controller before each enrolment of a new card.

In some embodiments, there may be provided a number of ways in which more complex or precise programs can be entered to the system.

A network link, such as a USB or TCP/IP port 328 or similar may be provided in the controller 100 for direct connection to computer perhaps via the Internet. This, along with some software can allow more complex settings to be added into a programme. In addition, it can allow a user to extract a report of use of the appliance.

A serial port 300, such as an RS485 port, may be provided in the controller 100 for connection to the computer through a suitable access control product. This would connect the controller to the computer and allow full programming and reporting.

A token programmer may be used to program RFID cards with more complex programmes. These cards may then be presented to the controller and the programmes will be applied. Hence the controller may allow input of both preset programmes and user-definable, or user-adjustable programmes.

A default programme may be set as follows:

Time and date when time setting card is presented: 9.00am, Monday

Weekday viewing allowance: 4 hours

Weekend viewing allowance: 6 hours

Always on after: 7.00pm

It will be understood that the present invention has been described above purely by way of example, and modifications of detail can be made within the scope of the invention.

The Applicant asserts design right and/or copyright in the accompanying drawings.

Each feature disclosed in the description, and (where appropriate) the claims and drawings may be provided independently or in any appropriate combination.

Reference numerals appearing in the claims are by way of illustration only and shall have no limiting effect on the scope of the claims.

1. A controller for controlling the supply of electrical power to an appliance, the controller being operative to complete or to disconnect a supply of electricity to electrical apparatus in accordance with a programmed time schedule, the time schedule of the controller being programmable by means of a programming object that is removable from the controller during operation.

2. A controller according to claim 1 in which the schedule defines a maximum period of operation of the appliance within a time interval.

3. A controller according to claim 2 in which the time interval is a day.

4. A controller according to any preceding claim in which the programmed time schedule permits the appliance to be operated for a predetermined duration in each period of 24 hours.

5. A controller according to claim 3 or claim 4 in which the schedule is varied in dependence upon the day of the week.

6. A controller according to claim 5 in which a first period can be specified for week days and an alternative period is specified for weekend days.

7. A controller according to any preceding claim in which the controller is operative to interact with the programming object without making an electrical connection with it.

8. A controller according to claim 7 in which the programming object is operative to interact with the controller by exchange of electromagnetic signals.

9. A controller according to claim 8 in which the electromagnetic signals are RF signals.

10. A controller according to claim 9 in which the controller is operative to interact with an RFID card.

11. A controller according to claim 10 which is arranged to interact with such a card when the card is brought into close proximity with the controller.

12. A controller according to any preceding claim which is configured not to respond to a programming object until that object has been enrolled for use with the controller.

13. A controller according to any preceding claim configured to receive and secure a power supply cord for the appliance.

14. A controller according to claim 13 configured to permit the supply cord to be directly wired into the controller.

15. A controller according to claim 13 configured to receive and secure a mains supply plug to which the supply cord is connected.

16. A controller according to claim 15 in which the plug is secured beneath a locking lid that can be opened by an authorised person.

17. A controller according to claim 16 in which the lid can be opened by application of a suitable programming object to the controller.

18. A controller according to claim 16 wherein the lid can be opened by release of a physical lock, such as a key operated lock.

19. A controller according to claim 17 or 18 further comprising means for detecting when the lid is open.

20. A controller according to claim 18 or claim 19 wherein opening of the lid causes the controller to enter a mode in which additional programming of the controller is enabled.

21. A controller according to claim 20 wherein the mode allows programming objects may be enrolled for use with the controller.

22. A controller according to any of claims 16 to 21 wherein at least one of the fixing means used to secure the casing of the controller is obscured when the lid is closed.

23. A controller according to claim 22 wherein all of the fixing means are obscured when the lid is closed.

24. A controller according to any preceding claim wherein the power supply cord is connected to the appliance via a plug or socket.

25. A controller according to claim 24 wherein the supply cord is provided with a locking plug or socket to secure the supply cord to the appliance.

26. A controller according to claim 15 wherein the plug is secured within a socket which allows insertion of the pins of the plug into the socket, but which seizes at least one of the pins of the plug to prevent removal of the plug from the socket.

27. A controller for controlling the supply of electrical power to an appliance substantially as herein described with reference to the accompanying drawings.

28. Apparatus for controlling the supply of electrical power to an appliance comprising a controller according to any preceding claim and one or more programming objects.

29. Apparatus according to claim 28 that includes a plurality of programming objects, each of which performs a predetermined programming function.

30. Apparatus according to claim 29 that includes one or more of the following: a programming object that sets a predetermined time schedule, a programming object that effects an incremental change to a time schedule, a programming object that resets the apparatus to a default condition, a programming object that permits unlimited use of the appliance and a programming object that prohibits all use of the appliance.

31. Apparatus according to claim 30 that includes programming objects which perform administrative tasks such as setting a clock or releasing a power connector from the controller.

32. Apparatus according to any one of claims 28 to 31 in which each programming object is labelled to indicate the programming function that it will perform.

33. Apparatus according to any of claims 28 to 32 wherein the set of programming objects includes at least two programming objects, each having defined functions, the objects being mutually visibly distinct.

34. Apparatus according to claim 33 wherein each of the mutually visibly distinct programming objects has a unique colour.

35. Apparatus according to any one of claims 28 to 34 in which the or each programming object includes an electronic token.

36. Apparatus according to any one of claims 28 to 35 wherein a set containing at least three programming objects is provided, a first of which adds a predetermined increment to the time allowance, a second of which removes a predetermined amount from the time allowance and at least a third of which performs at least one of the following functions: cancelling all allowance of time for a predetermined period and allowing uninterrupted use of the appliance for a predetermined period.

37. Apparatus according to any one of claims 28 to 36 in which the controller will act upon a programming object only if that object has been previously enrolled for use with the controller.

38. Apparatus according to any one of claims 28 to 37 in which each programming object can be enrolled for use in a controller by first introducing an enrolment programming object to the controller and then introducing a further programming object that is to be enrolled.

39. Apparatus according to any one of claims 28 to 38 in which each programming object and each controller can be programmed with an authorisation code, each controller responding only to those programming objects that have an appropriate authorisation code.

40. Apparatus according to claim 39 in which the authorisation code corresponds to a geographical limitation, a department within an organisation, or a type or class of appliance.

41. Apparatus for controlling the supply of electrical power to an appliance substantially as herein described with reference to the accompanying drawings.

42. A system for controlling the time of operation of an electrical appliance comprising a controller and a set of objects for programming the controller, in which the controller is operative to complete or interrupt a power supply circuit to an appliance in accordance with a timing programme, the timing programme being configurable by a user by means of the programming objects.

43. A system according to claim 42 comprising a plurality of controllers that can be programmed by one set of programming objects.

44. A system according to claim 42 or claim 43 in which each programming object is labelled to indicate the programming function that it will perform.

45. A system according to any one of claims 42 to 44 in which each programming object is used to perform its function by bringing it into proximity with the controller.

46. A system according to claim 45 in which each programming object is an RFID card.

47. A system according to any one of claims 42 to 46 in which each controller can be connected to a mains supply and has a mains outlet socket into which a mains plug of an appliance can be inserted and secured to resist unauthorised removal.

48. A system according to any one of claims 42 to 47 in which removal of the plug can be accomplished by introducing a suitable programming object to the controller.

49. A system for controlling the time of operation of an electrical appliance substantially as herein described with reference to the accompanying drawings.

50. A programming object for controlling the function or for programming a controller for controlling the supply of electrical power to an appliance.

51. A programming object according to claim 50 comprising an electronic token.

52. A programming object according to claim 51 comprising an RFID card.

53. A set of programming objects according to any one of claims 50 to 52 each of which is configured to perform a specific programming or control function.

54. A set of programming objects according to claim 53, each of which bears an indication of the function that it is configured to perform.

55. A set of programming objects according to claim 53 or claim 54, comprising at least two mutually visibly distinct objects each having defined functions.

56. A set of programming objects according to claim 55 wherein each of the visibly distinguishable programming objects has a unique colour.

57. A set of at least three programming objects each having defined functions, the objects each having a different colour.

58. A method of programming a controller for controlling an electrical appliance in which one or more programming objects is presented to the controller, each programming object causing the controller to perform a specified programming function.

59. A method according to claim 58 further including the step of removing the programming objects from the vicinity of the controller following programming of the controller.

60. A method of programming a controller for controlling an electrical appliance substantially as herein described with reference to the accompanying drawings.
